(19) United States
(12) Patent Application Publication
(10) Pub. No.: US 2017/0068109 A1
(43) Pub. Date: Mar. 9, 2017

(54) EYEWEAR WITH ADJUSTABLE LENS HEIGHT

(71) Applicant: Oceanus Investment Inc., Mahe (SC)

(72) Inventors: David CHAO, Saratoga, CA (US); Chien-Ho LIN, Chiayi (TW)

(21) Appl. No.: 15/063,020

(22) Filed: Mar. 7, 2016

(30) Foreign Application Priority Data
Sep. 4, 2015 (TW) 104129385

(51) Int. Cl. G02C 5/00; G02C 7/06

(52) U.S. Cl. CPC G02C 5/001; G02C 7/06

(57) ABSTRACT

An eyewear includes a lens frame, a first lens unit and an adjustment unit. The first lens unit is disposed in the lens frame and includes a plurality of lenses that are aligned in a front-rear direction. At least one of the lenses is a movable lens that is movable relative to the lens frame and that has a plurality of correction zones. The correction zones have different curvatures and are arranged in a top-bottom direction. The adjustment unit is disposed on the lens frame, and is operable to move the movable lens in the top-bottom direction relative to the lens frame.

CROSS-REFERENCE TO RELATED APPLICATION

This application claims priority of Taiwanese Patent Application No. 104129385, filed on Sep. 4, 2015.

### FIELD

The disclosure relates to an eyewear, more particularly to an eyewear with adjustable lens height.

### BACKGROUND

Referring to FIG. 1, a conventional eyewear for correcting myopia includes a frame 6 that is worn by a wearer and that corresponds to left and right eyes of the wearer, and two corrective lenses 7 that are disposed in the frame 6. Each of the corrective lenses 7 has a fixed curvature, which is determined based on an eyeglass prescription of the wearer, for providing a clear vision for the wearer. However, since higher optical power is required for distant vision and lower optical power is desired for near vision, the eyewear with the corrective lenses 7 having fixed curvature cannot satisfy the need of the wearer when performing different activities.

Bifocal, trifocal and progressive lenses are different types of lenses for another conventional eyewear that is used to correct presbyopia. The bifocal lens has an upper portion that is for distant vision, and a lower portion that is for near vision and that has a different optical power comparing with that of the upper portion. The trifocal lens is similar to the bifocal lens but further has an intermediate portion that is located between the upper and lower portions, and that has an optical power in between the optical powers of the upper and lower portions. The progressive lens is similar to the bifocal lens, but provides a gradual transition in optical power from the upper portion to the lower portion, and is free of visible line that is formed between the upper and lower portions.

Since the bifocal and trifocal lenses are divided into the above-mentioned portions, when the wearer wears the conventional eyewear having the bifocal or trifocal lenses, he or she has to hold the conventional eyewear and adjust the position of the eyewear for sighting through a desirable portion of the lenses, which is relatively inconvenient. Moreover, since the difference between the optical powers of the above-mentioned portions of each of the lenses may be large, the wearer may suffer from dizziness during transition between the upper and lower portions, and may experience difficulty in focusing at objects that are located at various distances.

In contrast to the bifocal and trifocal lenses, the progressive lens allows for clear vision at various distances. However, the wearer say suffer from eye strain and fatigue when focusing on a particular object located at a certain distance for an extended period of time.

Therefore, there is a need for improvement in the conventional eyewear.

### SUMMARY

Therefore, an object of the disclosure is to provide an eyewear that can alleviate at least one of the drawbacks of the prior arts.

According to the disclosure, the eyewear includes a lens frame, a first lens unit and an adjustment unit.

The lens frame defines an imaginary reference line that is parallel to a line passing through centers of left and right eyes of a wearer when the lens frame is worn on the wearer. The first lens unit is disposed in the lens frame and includes a plurality of lenses that are aligned in a front-rear direction which is transverse to the reference line. At least one of the lenses is a movable lens that is movable relative to the lens frame and that has a plurality of correction zones. The correction zones have different curvatures and are arranged in a top-bottom direction which is transverse to the reference line. The adjustment unit is disposed on the lens frame, and is operable to move the movable lens in the top-bottom direction relative to the lens frame.

### BRIEF DESCRIPTION OF THE DRAWINGS

Other features and advantages of the disclosure will become apparent in the following detailed description of the embodiments with reference to the accompanying drawings, of which:

FIG. 1 is a top view illustrating a conventional eyewear;

FIG. 2 is a top view illustrating a first embodiment of an eyewear according to the disclosure;

FIG. 3 is a front view of the first embodiment;

FIG. 4 is a side view of a first lens unit of the first embodiment;

FIG. 5 is a view similar to FIG. 3, but with the lens power of the eyewear adjusted;

FIG. 6 is a front view illustrating a second embodiment of the eyewear according to the disclosure;

FIG. 7 is a front view illustrating a third embodiment of the eyewear according to the disclosure; and

FIG. 8 is a front view illustrating a fourth embodiment of the eyewear according to the disclosure.

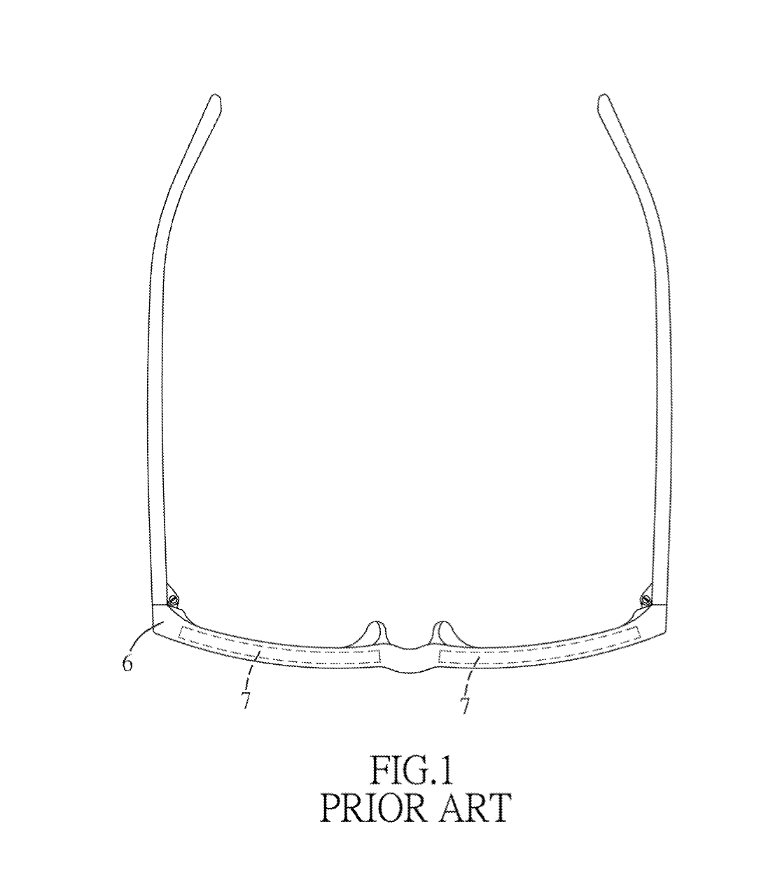

### DETAILED DESCRIPTION

Before the disclosure is described in greater detail, it should be noted that like elements are denoted by the same reference numerals throughout the disclosure.

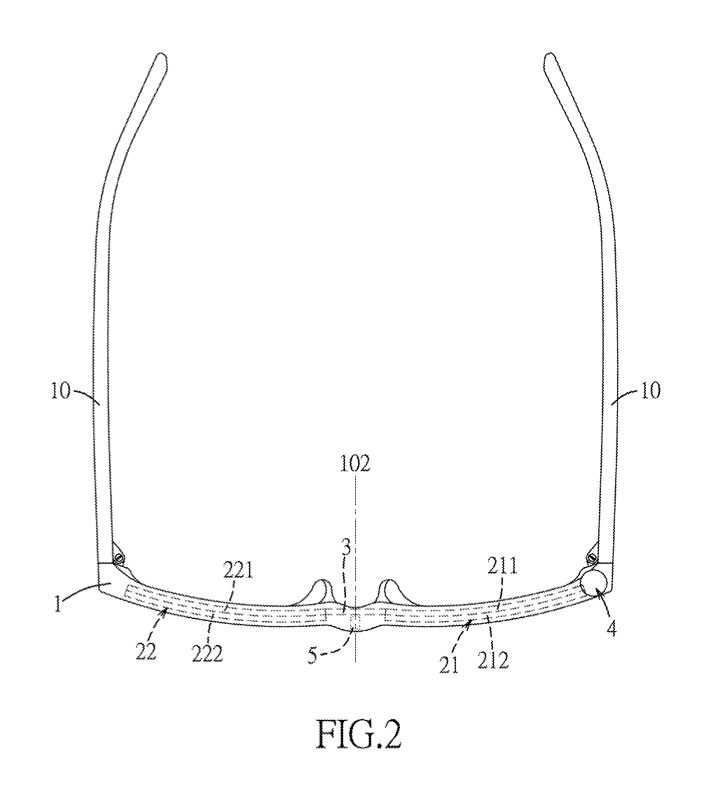

Referring to FIGS. 2 to 4, the first embodiment of an eyewear according to the present disclosure includes a lens frame 1, two temples 10, a first lens unit 21, a second lens unit 22, a connector 3, an adjustment unit 4 and a display unit 5.

The lens frame 1 defines an imaginary reference line 101 that is parallel to a line passing through centers of left and right eyes of a wearer (not shown) when the lens frame 1 is worn on the wearer. The lens frame 1 is formed with two slide slots 11 therein that correspond in position to the left and right eyes of the wearer, respectively.

The temples 10 are respectively connected to two opposite sides of the lens frame 1.

The first and second lens units 21, 22 are disposed in the lens frame 1, and respectively correspond in position to the left and right eyes of the wearer. Each of the first and second lens units 21, 22 includes two lenses. Since the first and second lens units 21, 22 have similar structures, only the first lens unit 21 will be described in detail hereinafter for the sake of brevity.

In this embodiment, one of the lenses of the first lens unit 21 is a stationary lens 212, and the other one of the lenses of the first lexis unit 21 is a movable lens 211. The stationary lens 212 and the movable lens 211 are aligned in a front-rear direction 102 which is transverse to the reference line 101. More specifically, the stationary lens 212 is located in front of the movable lens 111 with respect to the wearer. The second lens unit 22 also has a movable lens 221 and a stationary lens 222.

The stationary lens 212 is fixedly disposed in the lens frame 1, and has a plurality of correction zones 200 (see FIG. 4). The correction zones 200 have different curvatures, are arranged in a top-bottom direction 103 which is transverse to the reference line 101, and are interconnected in the top-bottom direction 103.

The movable lens 211 is movable relative to the lens frame 1, has a plurality of the correction zones 200, and is slidably disposed in a corresponding one of the slide slots 11 of the lens frame 1.

Each of the correction zones 200 of the stationary lens 212 has an optical power different from that of an adjacent one of the correction zones 200 of the movable lens 211. In one example, the stationary lens 212 of the first lens unit 21 includes three of the correction zones 200 respectively having optical powers of +0.5, +1, +0.5 diopters from top to bottom. The movable lens 211 of the first lens unit 21 includes five of the correction zones 200 respectively having optical powers of +0.5, +1, +1.5, +2, +2.5 diopters from top to bottom. It is worth mentioning that the correction zones 200 of the first lens units 21 and the correction zones 200 of the second lens units 22 may or may not have the same optical powers.

In a modification of the embodiment, the correction zones 200 of the stationary lens 232 may be omitted and the stationary lens 212 may have a fixed optical power. In certain embodiments, each of the lenses may be configured to be the movable lens 211 that is movable relative to the lens frame 1.

In other variations of the embodiment, the number of the lenses of each of the first and second lens units 21, 22 may be more than two, and the number of the movable lenses 211, 221 of each of the first and second lens units 21, 22 may be more than one.

The connector 3 is disposed in the lens frame 1, and has two opposite ends 31, 32 fixedly and respectively connected to the movable lens 211 of the first lens unit 21 and the movable lens 221 of the second lens unit 22 for bridging the first and second lens units 21, 22.

The adjustment unit 4 is disposed on the lens frame 1, and includes a toothed rack 41 and an adjusting member 42. The toothed rack 4 is connected to a periphery of the movable lens 211 of the first lens unit 21 and is adjacent to a corresponding one of the temples 10. The adjusting member 42 meshes with the toothed rack 41 and is operable to move the toothed rack 41 together with the movable lens 211 of the first lens unit 21 and the movable lens 221 of the second lens unit 22 in the top-bottom direction 103 relative to the lens frame 1 in the slide slots 11. In this embodiment, the toothed rack 41 and the movable lens 211 of the first lens unit 21 are integrally formed, and the adjusting member 42 is configured as a screw.

It should be noted that in other variations of the embodiment, the toothed rack 41 and the adjusting member 42 may be disposed on the lens frame 1 at a position that bridges the first and second lens units 21, 22, so that the stress exerted on the first and second lens units 21, 22 is distributed more evenly when the adjusting member 42 is operated, and that the first and second lens units 21, 22 are less likely to become slanted with respect to the lens frame 1. Comparing with the adjustment unit 4 disposed adjacent to the corresponding one of the temples 10, such modification allows the slide slots 11 to be formed less precisely.

Alternatively, in other variation of the embodiment, the toothed rack 41 may be connected to a periphery of the movable lens 221 of the second lens unit 22.

The display unit 5 includes an indicating scale 51 that is disposed on the lens frame 1 at the position that bridges the first and second lens units 21, 22, and a pointer 52 that is connected to and movable together with the connector 3 in the top-bottom direction 103 along the indicating scale 51, so as to indicate the optical power of the first and second lens units 21, 22. As long as the optical power of the first and second lens units 21, 22 is indicated visibly on the eyewear, the structure of the display unit 5 is not limited to that provided in this embodiment, and the display unit 5 may be disposed on one of the temples 10 or other positions on the lens frame 1 so as to improve aesthetic appearance of the eyewear.

When a change of the optical power is needed, the adjusting member 42 is manually turned by the wearer so as to move upwardly or downwardly the toothed rack 41 together with the movable lens 211, 221 of each of the first and second lens units 21, 22 relative to the lens frame 1 until a desirable optical power is indicated by the pointer 52 on the indicating scale 51. Since the adjusting member 42 is configured as the screw in this embodiment, a head part of the screw can be turned for an adjustment of the optical power.

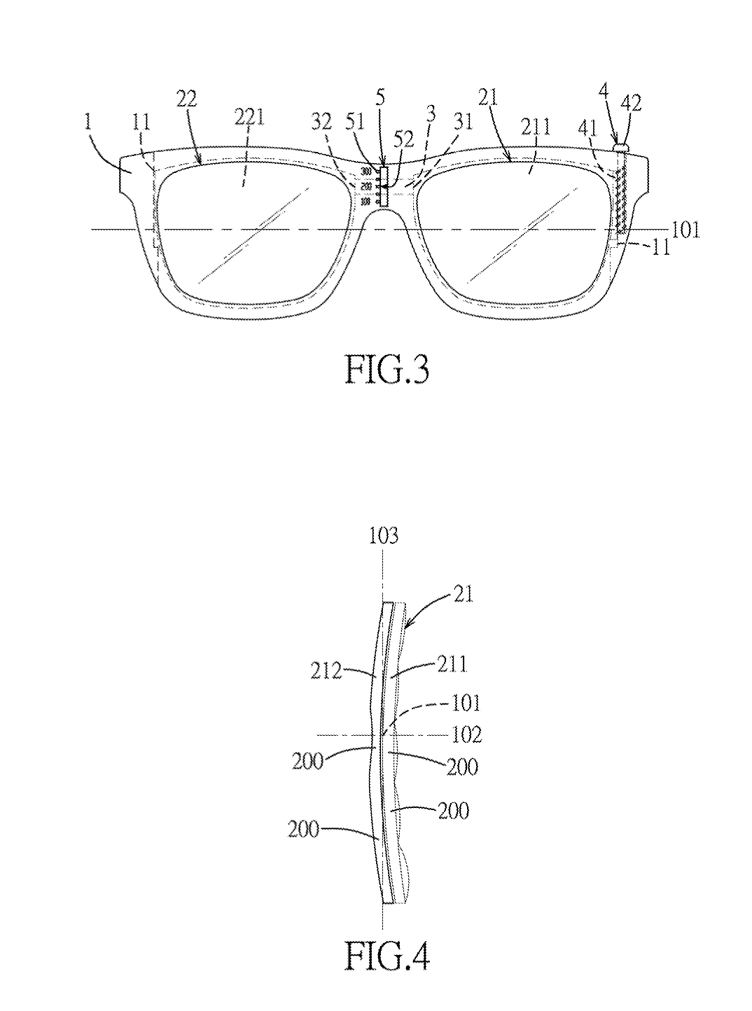

Referring to FIGS. 3 and 5, in one example, the eyewear has an optical power of +2 diopters (shown in FIG. 3 as 200) before the adjustment. The adjusting member 42 is turned to move upwardly the toothed rack 41 together with the movable lens 211,221 of each of the first and second lens units 21, 22 relative to the lens frame 1 until the optical power is +2.5 diopters (shown in FIG. 5 as 250). In other example, the optical power may be adjusted to be, but not limited to, +3 diopters.

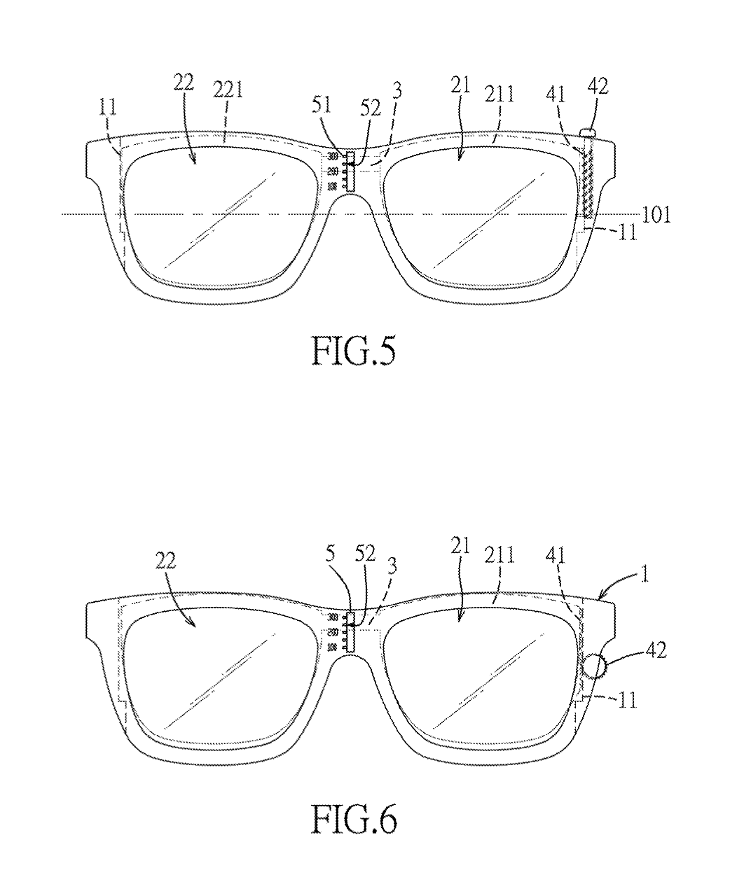

Referring to FIG. 6, a second embodiment of the eyewear according to the disclosure is similar to the first embodiment, and the difference resides in that the adjusting member 42 of the second embodiment is configured as a pinion gear. Such configuration enables the wearer to adjust the optical power by using only one finger, thereby improving convenience for the wearer when the adjustment is needed.

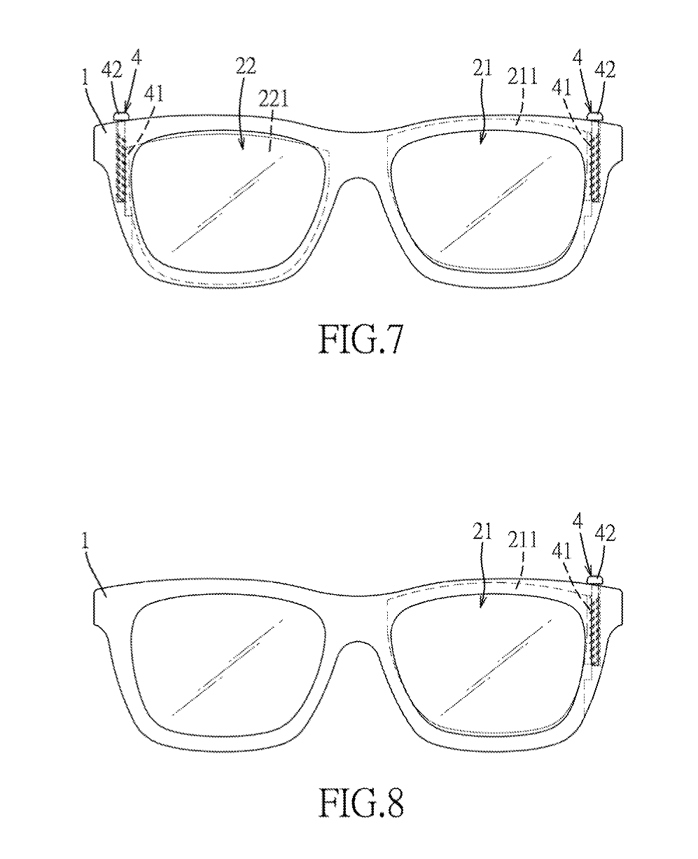

Referring to FIG. 7, a third embodiment of the eyewear according to the disclosure is similar to the first embodiment, and the difference resides in that the adjustment unit 4 of the third embodiment includes two of the toothed racks 41 and two of the adjusting members 42, and the connector 3 and the display unit 5 (see FIG. 3) of the first embodiment are omitted. In the third embodiment, each of the toothed racks 41 is connected to the periphery of the movable lens 211,221 of a respective one of the first and second lens units 21, 22. Each of the adjusting members 42 meshes with a respective one of the toothed racks 41, and is operable to move the movable lens 211,221 of a corresponding one of the first and second lens units 21, 22 in the top-bottom direction 103 relative to the lens frame 1 in a corresponding one of the slide slots 11. Since the optical powers of the first and second lens units 21, 22 can be adjusted separately and independently, the eyewear of the third embodiment is suitable for wearers having different correction needs for the left and right eyes.

Referring to FIG. 8, a fourth embodiment of the eyewear according to the disclosure is similar to the first embodiment, and the difference resides in that the second lens unit 22, the connector 3 and the display unit 5 of the first embodiment (see FIG. 3) are omitted, and the lens frame 1 of the fourth embodiment is formed with only one of the slide slots 11 which permits the movable lens 211 of the first lens unit 21 to be slidably disposed therein. The first lens unit 21 of the fourth embodiment is disposed to correspond in position to one of the left and right eyes of the wearer. In one example, the first lens unit 21 of the fourth embodiment corresponds in position to the left eye of the wearer, and a lens with no optical power is disposed in the lens frame 1 at a position corresponding to the right eye of the wearer, as illustrated in FIG. 8. Alternatively, in a modification of the embodiment, the first lens unit 21 of the fourth embodiment may correspond in position to the right eye of the wearer depending on actual needs. The eyewear of the fourth embodiment is suitable for a wearer with only one of the left and right eyes requiring vision correction.

By virtue of the adjustment unit 4 and the movable lens 211,221 of each of the first and second lens units 21, 22, the optical power of the first and second lens units 21, 22 can be adjusted based on different needs. Comparing with the above-mentioned conventional eyewear with the bifocal or trifocal lenses, the eyewear of the present disclosure allows for clear vision at various distances and prevents the occurrence of dizziness switching among different correction zones 200. Furthermore, the wearer does not have to hold the eyewear of the present disclosure for sighting through selected ones of the correction zones 200. Moreover, eye strain and fatigue experienced by wearing the conventional eyewear with the progressive lenses may be alleviated when wearing the eyewear of the present disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An eyewear comprising:
a lens frame defining an imaginary reference line that is parallel to a line passing through centers of left and right eyes of a wearer when said lens frame is worn on the wearer;
a first lens unit disposed in said lens frame and including a plurality of lenses that are aligned in a front-rear direction which is transverse to the reference line, at least one of said lenses being a movable lens that is movable relative to said lens frame and that has a plurality of correction zones, said correction zones having different curvatures and being arranged in a top-bottom direction which is transverse to the reference line; and
an adjustment unit disposed on said lens frame, and operable to move said movable lens in the top-bottom direction relative to said lens frame.

2. The eyewear as claimed in claim 1, wherein said lens frame is formed with a slide slot permitting said movable lens to be slidably disposed therein.

3. The eyewear as claimed in claim 2, wherein said adjustment unit includes a toothed rack that is connected to a periphery of said movable lens, and an adjusting member that meshes with said toothed rack and that is operable to move said toothed rack together with said movable lens in the top-bottom direction relative to said lens frame in said slide slot.

4. The eyewear as claimed in claim 3, wherein said toothed rack and said movable lens are integrally formed.

5. The eyewear as claimed in claim 3, wherein said adjusting member is configured as a screw.

6. The eyewear as claimed in claim 3, wherein said adjusting member is configured as a pinion gear.

7. The eyewear as claimed in claim 1, further comprising a second lens unit that is disposed in said lens frame, and that includes a plurality of lenses aligned in the front-rear direction, at least one of said lenses of said second lens unit being a movable lens that is movable relative to said lens frame and that has a plurality of correction zones, said correction zones having different curvatures and being arranged in the top-bottom direction, said first and second lens units respectively corresponding in position to the left and right eyes of the wearer.

8. The eyewear as claimed in claim 7, wherein said lens frame is formed with two slide slots each permitting said movable lens of a respective one of said first and second lens units to be slidably disposed therein.

9. The eyewear as claimed in claim 8, wherein said adjustment unit includes two toothed racks each being connected to a periphery of said movable lens of a respective one of said first and second lens units, said adjustment unit further including two adjusting members each meshing with a respective one of said toothed racks, and being operable to move said movable lens of a corresponding one of said first and second lens units in the top-bottom direction relative to said lens frame in a corresponding one of said slide slots.

10. The eyewear as claimed in claim 7, further comprising a connector that has two opposite ends each being connected fixedly to said movable lens of a respective one of said first and second lens units for bridging said first and second lens units.

11. The eyewear as claimed in claim 10, further comprising a display unit that includes an indicating scale disposed on said lens frame, and a pointer connected to and movable together with said connector in the top-bottom direction along said indicating scale so as to indicate optical power of said first and second lens units.

12. The eyewear as claimed in claim 10, wherein said adjustment unit includes a toothed rack that is connected to a periphery of said movable lens of one of said first and second lens units, and an adjusting member that meshes with said toothed rack and that is operable to move said toothed rack together with said movable lens of said first lens unit and said movable lens of said second lens unit in the top-bottom direction relative to said lens frame.

13. The eyewear as claimed in claim 12, wherein said adjusting member is configured as a screw.

14. The eyewear as claimed in claim 12, wherein said adjusting member is configured as a pinion gear.

15. The eyewear as claimed in claim 7, wherein said correction zones of said movable lens of said second lens unit are interconnected in the top-bottom direction.

16. The eyewear as claimed in claim 1, wherein each of said lenses of said first lens unit has a plurality of said correction zones.

17. The eyewear as claimed in claim 1, wherein said first lens unit is disposed to correspond in position to one of the left and right eyes of the wearer.

18. The eyewear as claimed in claim 1, wherein said correction zones are interconnected in the top-bottom direction.
